(19) United States
(12) Patent Application Publication
(10) Pub. No.: US 2009/0177602 A1
(43) Pub. Date: Jul. 9, 2009

(54) SYSTEMS AND METHODS FOR DETECTING UNSAFE CONDITIONS

(75) Inventors: Huazhong Ning, Urbana, IL (US); Wei Xu, Los Gatos, CA (US); Yue Zhou, Champaign, IL (US); Yihong Gong, Saratoga, CA (US); Thomas Huang, Urbana, IL (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/950,776

(22) Filed: Dec. 5, 2007

Related U.S. Application Data
(60) Provisional application No. 60/913,823, filed on Apr. 25, 2007.

(51) Int. Cl. G06N 3/02

(52) U.S. Cl. 706/21

(57) ABSTRACT

Systems and methods are disclosed to detect unsafe system states by capturing and analyzing data from a plurality of sensors detecting parameters of the system; and applying temporal difference (TD) learning to learn a function to approximate an expected future reward given current and historical sensor readings.

The present application claims priority to Provisional Application Ser. No. 60/913,823, filed Apr. 25, 2007, the content of which is incorporated by reference.

The present invention relates to unsafe condition detection.

### BACKGROUND

The increasing use of sensor technologies enables applications of increasing importance that automatically capture and process the basic parameters of and make decision for complex systems, such as in-vehicle information system, computer network, and so on. The direct goal is to monitor the performance of the complex system by analyzing a multi-sensor output to detect unsafe states of the system before it collapses so that certain measures can be taken in advance to avoid the system collapse or failure. An efficient detector of unsafe states can largely save human from economical loss (e.g. collapse of computer network) and from exposure to dangerous situation (e.g. driving safety), and this is called “unsafety detector”. The unsafety detector is a special case of anomaly detection. Anomaly detection has the potential to impact a wide range of important real-world applications, ranging from security, finance, public health, medicine, biology, environmental science, manufacturing, astrophysics, business, and economics.

Rule-based methods have been used to check the current and/or past sensor readings against a set of predefined rules. A violation or a combination of violations of the rule(s) is regarded as an anomaly. A more complicated rule-based approach characterizes each anomalous pattern with a rule. The significance of each rule is carefully evaluated using Fisher's Exact Test and a randomization test. Rule-based methods may work well on simple scenarios, but it is impractical to predefine rules for complex applications such as driving safety in this paper.

Other techniques have used statistical methods. Many of them learn a generative model from the training data that are labelled into two classes: normal or anomalous. Then the Bayesian approach is used to estimate the probability of each class for the newly incoming data points and anomaly is alarmed if the probability of anomalous class exceeds a predefined threshold. Sometimes only the generative model of the normal data is learned because the anomalous data can be rare. In this case, the Bayesian approach can still be used to find the outliers. Some statistical methods train two-category classifier using SVM or neural network that classifies the incoming data as normal or anomalous. The above statistical methods require large sets of labelled data for training. They cannot predict the anomaly in advance. Another drawback is that they overlook the long-term temporal correlations of the sensor data.

The third category of methods involves signal processing techniques. For instance, one known approach automatically models and searches relationships between the flow intensities measured at various points across the system. If the modelled relationships hold all the time, they are regarded as invariants of the underlying system. For example, wavelets have been used for detecting disease outbreaks in temporal syndromic data.

A rule-based approach to detect the unsafe states is impractical and machine learning methods are more desirable. However, the standard supervised learning methods such as classification and regression cannot be applied to safety detection, because these methods require sample input-output pairs from the functions to be learnt and the pairs are usually unavailable due to the labelling issue.

With respect to the labelling issue, suppose that the sensor readings at time t is Xₜ and X_{0:t} indicates all the sensor readings from time 0 to t. Let J be the danger level function and J(X_{0:t}) be the danger level given all past sensor readings. Our goal is to learn the danger level function J from the training data (sensor data). An intuitive idea is to parameterize the danger level function and then estimate the parameters by linear or non-linear regression/classification, i.e. by supervised learning. However, supervised learning requires manually labelled training data, i.e., assigning a danger level to the sensor readings at any time t. Then a problem arises: can a person objectively assign the danger level? However, it is hard to judge that speed exceedance is more or less unsafe than a weaving style of driving. Similarly, it is impractical for a person to claim that the computer network is in safe or unsafe state by just looking at thousands of basic parameters such as CPU usage, network traffic, and memory usage. Hence, most of previous work labels the training data manually and subjectively. For instance, the driving stress labels have been derived by asking the drivers to fill out the subjective rating questionnaires immediately after each drive. In another research paper of driving safety, the drivers simulated drowsy behaviors according to the physiology study by the U.S. Department of Transportation. In these cases, the results are subjective since the learning relies on the subjectively labelled training data.

### SUMMARY

Systems and methods are disclosed to detect unsafe system states by capturing and analyzing data from a plurality of sensors detecting parameters of the system; and applying temporal difference (TD) learning to learn a function to approximate an expected future reward given current and historical sensor readings.

Implementations of the above aspect may include one or more of the following. The system can generate a danger function. The danger function can be values on a continuous and high-dimensional feature space. The danger function can be a suitable approximation J(Xₜ, r), where r is a vector of parameters. J(Xₜ, r) can be a linear function or a non-linear function. The non-linear function can be

$$J ( {X}_{t} , r ) = {\sum }_{i = 1}^{S} {α}_{i} {e}^{- \frac{{X}_{t} - {r}_{i}}{2 {σ}^{2}}} + β .$$

The danger function can be implemented as a neural network. The system can provide a discount factor α,0<α≦1, to the temporal difference dₛ=g(Xₛ, Xₛ₊₁)+αJ(Xₛ₊₁, r)−J(Xₛ, r). The system can treat the danger level as an expected future reward and using temporal difference (TD) learning to generate a danger function to approximate the expected future reward given current and historical sensor readings. The TD learning obtains an approximation by propagating a penalty/reward observable at collapse points or successful ends to the entire feature space following one or more predetermined constraints. New features can be extracted from raw data and the raw data can be transformed by \tilde{X}ₜ=T(X_{t-s:t}) where \tilde{X}ₜ is the new feature at time t. The transformation T can be applied to reduce a dimension of a source feature and summarize the information meaningful to unsafety detection. T can be empirically determined. The system can extract mean, max, min, and variance from each dimension of the sensor reading and weave from dimensions of lane position and steering wheel. The system can be applied to detecting driving safety. This can be done as a frequency of vehicle oscillation on the lane to detect a driver's skill, fatigue, and drowsiness. The system can generate a danger level function J(Xₜ), wherein J(Xₜ) implicitly provides a maximum probability that the system will collapse from a current state Xₜ. Transitioning from state Xₜ to Xₜ₊₁ incurs a danger level change g(Xₜ,Xₜ₊₁). J(Xₜ) satisfies Bellman's equation, for example

$$J ( {X}_{t} ) = {min}_{{X}_{t + 1}} ( g ( {X}_{t} , {X}_{t + 1} ) + J ( {X}_{t + 1} ) ) .$$

The system can apply an incremental gradient method or a nonlinear optimization method to globally determine J(Xₜ).

Advantages of the preferred embodiment may include one or more of the following. The system provides a general framework to detect unsafe system states. It uses temporal difference (TD) learning to approximate a danger level function that indicates how safe/unsafe of the system, by analyzing the multi-sensor data that captures the basic parameters of the system. The TD learning technique avoids the labelling issue. The TD learning approximates the danger level function by propagating the penalty and reward to the entire feature space following some constraints. The approach can be applied to, but not limited to, the application of driving safety. The experimental results and the live prototype system demonstrates the effectiveness of the approach. The TD learning procedure avoids the labelling issue where it is nearly impossible to label the training data with objective danger level, except at the collapse points where the extremal penalty can be assigned to the danger level and at the successful ends where a certain reward can be assigned. The general framework for monitoring unsafe system states can be applied to a wide range of applications that require realtime monitoring, as well as driving safety that is validated by the experiments where a large real dataset was collected to validate the system. The live prototype system for driving safety further demonstrates the robustness and efficiency of the framework.

### BRIEF DESCRIPTION OF THE DRAWINGS

FIG. 1 shows a general framework to detect unsafe states of a system whose basic realtime parameters are captured by multi-sensors.

FIG. 2A shows an exemplary diagram illustrating the safe/unsafe labeling issue.

FIG. 2B shows an exemplary diagram illustrating trajectories and sink points in a feature space.

FIG. 3 shows an exemplary danger function trained on two trajectories.

FIG. 4 shows an exemplary chart illustrating lane position, throttle acceleration, brake acceleration and velocity.

FIG. 5 shows an exemplary vehicle simulator with multi-sensors.

FIG. 6 shows an exemplary screen shot of a safety detection system for vehicles.

FIG. 7 shows exemplary danger level functions of two driving courses.

FIG. 8 shows an exemplary curve illustrating predictive performance of the unsafe detection system.

### DESCRIPTION

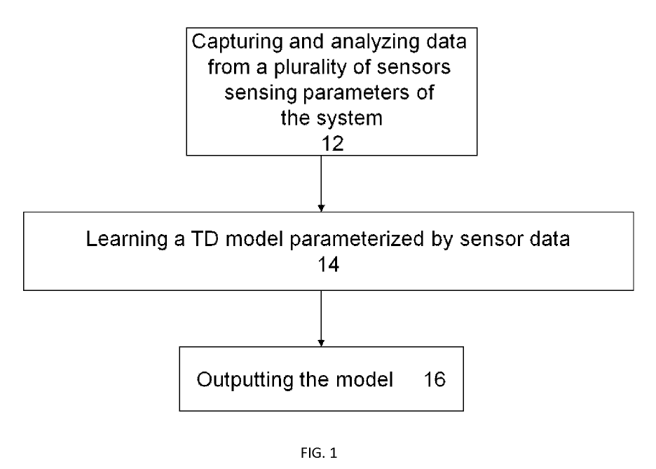

FIG. 1 shows a general framework to detect unsafe states of a system whose basic realtime parameters are captured by multi-sensors. The method of FIG. 1 learns a danger level function which can be used to alert the users in advance of dangerous situations so that certain measures can be taken to avoid an unsafe state such as a system collapse. To avoid the labelling issue, the system treats the danger level as expected future reward (penalty is regarded as negative reward) and use temporal difference (TD) learning to learn a function to approximate the expected future reward given the current and historical sensor readings. The TD learning obtains the approximation by propagating the penalty/reward observable at collapse points or successful ends to the entire feature space following some constraints. TD learning to approximate a danger level function that enables real-time monitoring of system state. This avoids the labelling issue. The system can be applied to, but not limited to, the application of monitoring of driving safety and the experimental results demonstrate the effectiveness of the approach.

Turning now to FIG. 1, the framework captures and analyzes data from a plurality of sensors sensing parameters of the system (12). Next, the framework generates or learns a TD model parameterized by sensor data (14). The system then outputs data for use in detecting unsafe states (16).

In one embodiment, the general framework for monitoring unsafe system states generates a danger level function which is approximated from training data and which outputs a indicator of the system states when new sensor readings are arriving. The system identifies the labelling issue existing in the domain of monitoring unsafe system states. Then the system formulates the problem as function approximation by TD learning so that the labelling issue is avoided.

“Unsafe” here means high probability of system collapse in the following time interval. Ideally, the system has an unsafety detector takes sensor readings as input and outputs a real value at any time stamp that indicates how safe/unsafe of the system state. The real value is called Danger Level and correspondingly the function is called Danger Level Function. The danger level should reveal, explicitly or implicitly, the probability that the system will collapse from the current state in the following time interval. Measures should be taken to avoid the collapse when the danger level increases/decreases beyond a threshold. Usually the dimensions of the sensor readings amounts to hundreds or even thousands observations per second when the system is complex. To ensure scalability, the system does not directly measure the danger level for most of the time except when system collapses or successfully ends.

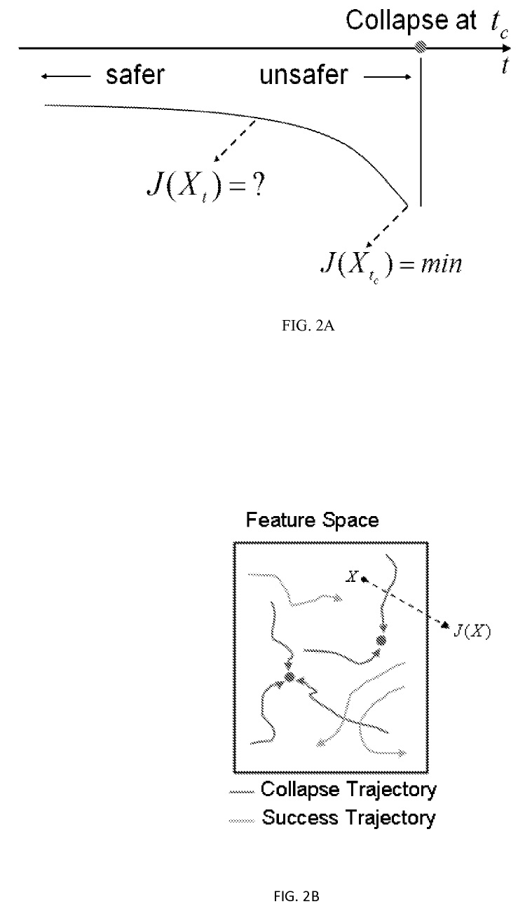

The method of FIG. 1 can determine unsafe situations. As illustrated in FIG. 2A, It is determinable in The method of FIG. 2A that it is definitely unsafe at a collapse point and that it is safe if the system completes its task successfully, although the safeness is uncertain at any other time. Furthermore, as illustrated in FIG. 2A, it is natural to assume that it becomes more and more unsafe when the system approaches the collapse point and that it is safer when the system stays far away from the collapse point. Instead of being predefined by some subjective rules, this constraint should be learnt from the training data. From above, it is reasonable to assign an extremum penalty (without loss of generality, it is negative and minimum herein) to the collapse point and to assign a certain positive reward when the system has successfully ended its operation. Then the penalty and reward are propagated to any other time according to the above learned constraint, which in turn forms the danger level function. Here the TD learning is used to accomplish the propagation and avoid the labelling issue.

The above constraint itself provides cues of how to manually (subjectively, too) label the training data. There are two kinds of labels which result in two categories of supervised learning approaches. The hard label has discrete values {1,−1}: 1 means a safe state and −1 indicates a unsafe state. Intuitively the system can label all the tᵤ seconds before any collapse point as “unsafe” (−1) and any other time as “safe”. Then a two-category classifier is trained on the manually labelled data. The soft label takes continuous value and is consistent with FIG. 2A, i.e., the bigger the value, the safer the system state. The soft label suggests linear or non-linear regression of the danger level function by appropriately parameterizing the function and estimating the parameters from the labelled training data. The soft label can be regarded as empirical expectation of the discounted future reward. TD learning provides a less noisy thus better supervision than the empirical expectation provided by the soft label. Both hard label and soft label approaches are compared with the TD learning method and the latter outperforms the former in the experiments of driving safety application as discussed in more details below.

To avoid the labelling issue, the system models the danger level as the expected future reward. A large value of negative expected future reward indicates highly dangerous state. On some specific points, the reward can be objectively assigned to the system. For example, the penalty (negative reward) assigned to a system crash can be decided based on its economic loss. With the reward suitably defined for the system, the system uses temporal difference (TD) learning to learn the danger level function. Roughly speaking, TD learning aims to estimate the expected future reward of the system given the current and historical sensor readings. TD learning is originally applied to reinforcement learning where TD learning is to estimate the so-called value function (i.e., expected future reward) given current and historic observations. Although the task differs from reinforcement learning in that the system does not need to find the optimal action, they share the same problem of estimating expected future reward.

TD learning was originally used in reinforcement learning whose primary goal is to provide effective suboptimal solutions to complex problems of planning and sequential decision making under uncertainty. TD learning draws on the theory of function approximation, the theory of dynamic programming, and theory of iterative optimization. More importantly, it combines two disciplines of dynamic programming and supervised learning to successfully solve the problems that neither discipline can address individually. The system utilizes this property to avoid the labelling issue and estimates the danger level function by iterative optimization.

The system first provides an intuitive idea of estimating the danger level function J by TD learning. In the new feature space, each segment of a system running course corresponds to a trajectory which ends with either collapse or success. As shown in FIG. 2B, the dotted curves indicate collapse trajectories, and green solid curves success trajectories. The collapse points can be viewed as sink points (dark points in FIG. 2B, and a moving point in the feature space will be either absorbed into a sink point or be stopped by external force, which forms collapse or success trajectory respectively. The training data correspond to sparse trajectories in the feature space; the danger level function can take values of a minimum (negative) penalty at the end of each collapse trajectory and a positive reward at the end of each success trajectory. But the values at any other points in the feature space are uncertain. The TD learning propagates the penalty/reward in the feature space so that the danger level function has values in the entire feature space.

Generally, the danger level function should depend on all the historical and current sensor data. But due to the voluminous sensor data, the system makes a simplification that the danger level function depends on only the past s seconds, i.e., J(X_{t-s:t})≈J(X_{0:t}). In other words, J outputs danger level by analyzing the sensor data in a window with length s. And the window is sliding by step t₀ so that J gives danger level after each duration t₀.

Instead of using the original sensor data, the system extracts new feature from each window by a transformation \tilde{X}ₜ=T(X_{t-s:t}) where \tilde{X}ₜ is the new feature at time t. The transformation T reduces the dimension of the original feature and summarizes the information meaningful to unsafety detection. Usually T is empirically determined but extracts information as much as possible. In the application of driving safety, T extracts mean, max, min, and variance from each dimension of the sensor reading and weave from the dimensions of lane position and steering wheel. Here weave is the frequency of vehicle oscillation on the lane, which reveals the driver's skills, fatigue, and drowsiness to some extent. These measurements are stacked and form the new feature \tilde{X}ₜ. And basically the danger level function depends on \tilde{X}ₜ.

Although the danger level function is basically determined by the new feature \tilde{X}ₜ, a more precise approach should consider the variables that have effects much longer than the window size s. These variables are called long-term variables. They can be either hidden states of the system or explicit measurements. For example, in the driving safety application, the driver's emotional state is a hidden variable of the entire system and affects the driving performance for hours/days; stop-sign violation is another long-term variable which reveals the driver's carelessness in a relatively long period. In the experiment, the system consider the long-term variable of individual mistakes (such as speeding, running stop signas and red-lights). Each individual mistake is accounted as a negative penalty that vanishes exponentially with the time. All of the penalties are added together and form the long-term variable that becomes a dimension of the feature \tilde{X}ₜ. In other words, the danger level function will depend not only on the feature extracted from the window but also on the long-term variable. From now on, \tilde{X}ₜ is simply represented as Xₜ.

The system can perform estimation by TD(λ). Here the learning involves two main choices: 1) the choice of an approximation architecture to represent the danger level function; 2) the choice of a training algorithm, i.e., a method to update the parameters of the architecture. For simple cases of function approximation, the function can be simply represented by a look-up table and a training algorithm approximates the function by iteratively updating the table.

In the preferred embodiment, the danger level function takes values on a continuous and high-dimensional feature space and the look-up table representation requires huge dimensions. Therefore, the system focuses on a suboptimal method that replaces the optimal danger level function J(Xₜ) with a suitable approximation J(Xₜ,r), where r is a vector of parameters. J(Xₜ,r) can be a linear or non-linear function of r or even a neural network with r as the weights. In this paper, both the linear and non-linear representations are used,

Linear

J(Xₜ,r)=Xₜr (1)

Non-linear

$$J ( {X}_{t} , r ) = {\sum }_{i = 1}^{S} {α}_{i} {e}^{- \frac{{X}_{t} - {r}_{i}}{2 {σ}^{2}}} + β \qquad ( 2 )$$

where r=(α₁, . . . , αₛ, r₁, . . . , rₛ, β) and S is the number of kernels.

The linear representation requires low computational cost and may have good generalization performance, especially when the dimension of Xₜ is high. The non-linear representation is originated from the idea of sink points in FIG. 2B, i.e., each rᵢ corresponds to a sink point, and S represents the number of sink points. A detailed description of the algorithm to learn the parameter vector r will be discussed next.

The danger level function J(Xₜ) implicitly gives the maximum probability that the system will collapse from the current state Xₜ. Assume that the system transitions from state Xₜ to Xₜ₊₁ incurs a danger level change g(Xₜ, Xₜ₊₁), then J(Xₜ) should satisfy the Bellman's equation

$$J ( {X}_{t} ) = {min}_{{X}_{t + 1}} ( g ( {X}_{t} , {X}_{t + 1} ) + J ( {X}_{t + 1} ) ) \qquad ( 3 )$$

Suppose there are N trajectories in the training data (X₁⁽ⁿ⁾, X₂⁽ⁿ⁾, . . . , X_{T}_{ₙ}⁽ⁿ⁾), n=1,2, . . . , N where Tₙ is the length of n-th trajectory. Denoted the real danger level at Xₜ⁽ⁿ⁾ of n-th trajectory as D(Xₜ⁽ⁿ⁾). Note that J(Xₜ,r) is an approximation of D(Xₜ). According to Eqn. 3,

$$D ( {X}_{t}^{( n )} ) = {\sum }_{s = t}^{{T}_{n} - 1} g ( {X}_{s}^{( n )} , {X}_{s + 1}^{( n )} ) + {M}^{( n )} \qquad ( 4 )$$

where M⁽ⁿ⁾ is the penalty/reward at the end of the n-th trajectory. The system considers the linear/nonlinear function of the form J(Xₜ,r) that approximates D(Xₜ), where r is a parameter vector. In our problem, r can be estimated by solving the least square optimization problem

$${min}_{r} {\sum }_{n = 1}^{N} {\sum }_{t = 1}^{{T}_{n}} {( J ( {X}_{t}^{( n )} , r ) - D ( {X}_{t}^{( n )} ) )}^{2} \qquad ( 5 )$$

The above least square problem can be solved by an incremental gradient method. For convenience, only one trajectory is considered for each iteration, i.e., the parameter vector r is updated iteratively by

$$Δ r = - γ {{\sum }^{T - 1}}_{t = 1} {∇}_{r} J ( {X}_{t} , r ) ( J ( {X}_{t} , r ) - D ( {X}_{t} ) ) \qquad ( 6 )$$

where (X₁, X₂, . . . , X_{T}) is a trajectory, ∇ᵣJ(Xₜ,r) is the partial differentiation with respect to r, and γ is a step size. After a few manipulations, Δr is rewritten as

$$Δ r = γ {\sum }_{t = 1}^{T - 1} {∇}_{r} J ( {X}_{t} , r ) {\sum }_{s = t}^{T - 1} {d}_{s} \qquad ( 7 )$$

where the quantities dₛ are defined by

dₛ=g(Xₛ,Xₛ₊₁)+J(Xₛ₊₁,r)−J(Xₛ,r) (8)

Here J(X_{T}, r)=M is fixed as the penalty/reward at the end of that trajectory. dₛ is called temporal difference. The key idea of TD learning is that g(Xₛ, Xₛ₊₁)+J(Xₛ₊₁, r) is a sample of the value J(Xₛ,r), and it is more likely to be correct because it is closer to J(X_{T}, r).

The temporal difference provides an indication as to whether or how much the estimate r should be increased or decreased. Usually dₛ is multiplied by a weight λ^{s-t},0≦λ≦1, to decrease the influence of farther temporal difference on ∇ᵣJ(Xₜ, r), i.e.,

$$Δ r = γ {\sum }_{t = 1}^{T - 1} {∇}_{r} J ( {X}_{t} , r ) {\sum }_{s = t}^{T - 1} {d}_{s} {λ}^{s - t} \qquad ( 9 )$$

The above equation provides a family of algorithms, one for each choice of λ, is known as TD(λ), and it is an off-line version. An on-line version of updating that corresponds to the transition (Xₛ, Xₛ₊₁) is

$$Δ r = γ {d}_{s} {\sum }_{t = 1}^{s} {λ}^{s - t} {∇}_{r} J ( {X}_{t} , r ) \qquad ( 10 )$$

The system may add a discount factor α,0<α≦1, to the temporal difference

dₛ=g(Xₛ,Xₛ₊₁)+αJ(Xₛ₊₁,r)−J(Xₛ,r) (11)

to weight near term more heavily than the distant. Then Eqn. 11 can be rewritten as

$$Δ r = γ {d}_{s} {\sum }_{t = 1}^{s} {( αλ )}^{s - t} {∇}_{r} J ( {X}_{t} , r ) \qquad ( 12 )$$

The discount factor is required if the length of the trajectory is infinite (or very long), otherwise the danger level will be infinite (or very large) for some feature points.

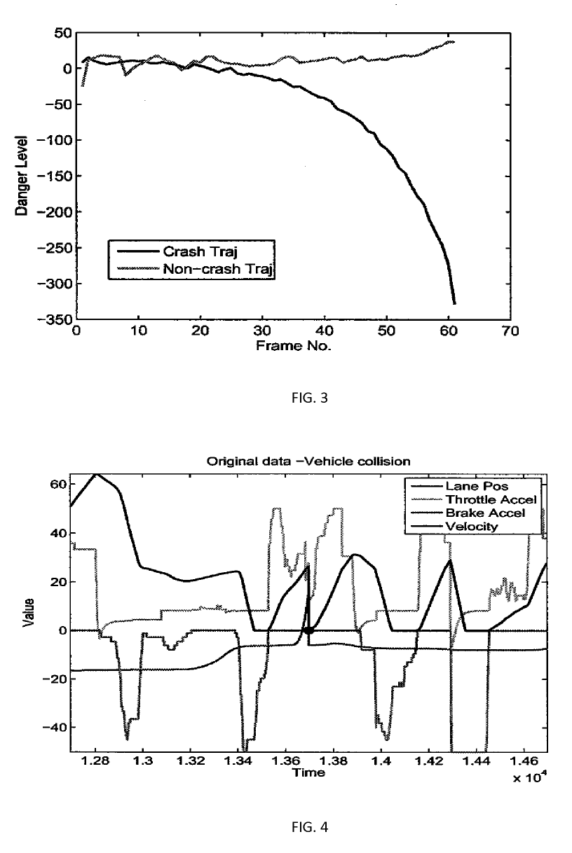

In various embodiments, both off-line and on-line TD(λ) with a discount factor can be used to iteratively update the parameter vector r, with training trajectories fed sequentially, and they give similar performance. FIG. 3 shows a danger level function trained on two trajectories, one is ended with car crash and the other is not. As expected, the crashed curve becomes smaller and smaller when approaching the crash point, and the danger level of the non-crashed trajectory is basically constant.

TD(λ) combined with function approximation may converge to a different limit for different values of λ and even the issue of convergence is complex. The only available convergence results refer to the linearly parameterized approximation architecture, but require constraints on the choice of the eligibility coefficients. One constraint is that the step size γₙ should be nonnegative and satisfy

$${\sum }_{n = 0}^{∞} {γ}_{n} = ∞$$

$$and$$

$${\sum }_{n = 0}^{∞} {γ}_{n}^{2} < ∞ ,$$

where n means the n-th trajectory. A popular choice is to let γₙ=c/(d+n) in the iteration for the n-th trajectory, where c and d are some positive constant. The convergence issue of nonlinear architecture is far from well studied. And there exist cases where TD(λ) may fail to converge. However, for many problems, nonlinear approximation does converge and leads to better performance than the linear approximation when the linear model cannot fit the function well. This also holds where nonlinear approximation comes from the idea of sink points.

The motivation for TD(λ) has strong theoretical basis. It even argues that as λ becomes smaller, there is a tendency for the quality of approximation to deteriorate. Nevertheless, empirical evidence shows that, for many problems, TD(λ) with λ<1 converges faster and achieves better performance than that obtained from TD(1). If the algorithm for a certain problem is convergent, the quality of the estimation should improve as the algorithm progresses iteratively. Therefore the system could rely more and more on the values of the nearest downstream states as the system should use a smaller λ. This suggests an empirical strategy that the system starts with a large λ and as learning progresses, decrease it to zero. TD(1) uses the discounted future reward as supervision for the current time step, hence it is nearly the same as using a soft label for supervised regression. TD(0) uses the predicted future reward at next time steps as the supervision for the current step. The difference between the two types of supervision is that the predicted future reward is usually a much more smoothed target than the discounted future reward and hence can make the learning easier.

Finally, the system needs to initialize the parameter vector r for the learning algorithm. Any random initialization of the parameter vector r satisfies the linearly parameterized approximation constructed by TD(λ), since the convergence is guaranteed as long as some constraints are satisfied. However the initialization is crucial to the quality of the nonlinear function approximation, and even the convergence may depend on the choice of initial value of r. The nonlinear representation of Eqn. 2 comes from the idea of sink points, so the intuitive choice of initial rᵢ can be the cluster centers of the features of collapse trajectories.

The general framework discussed above can serve a wide range of applications that need to detect unsafe system states by analyzing multi-sensor data. In one implementation, the system is applied to driving safety determination to demonstrate its effectiveness. Currently the ever-increasing traffic accidents due to a driver's diminished vigilance level poses a serious problem to the society. Drivers with a diminished vigilance level suffer from a declined in their perception, recognition, and vehicle-control abilities, and therefore pose a serious danger on the driver's and other people's lives. According to the National Highway Traffic Safety Administration (NHTSA), there are at least 100,000 crashes that are caused by drowsy drivers annually, which results in more than 1,500 fatalities and 71,000 injuries each year in U.S. Therefore, a system that actively monitors the states of the driver and the car and alert the driver of any unsafe driving condition is essential for increasing the driving safety.

To demonstrate its effectiveness, the framework has been applied to the real world application of driving safety. In this application, sensors are installed on the vehicle or attached to the human body to collect action parameters of the vehicle (such as braking, throttle, and lane position), and physiological (such as electrocardiogram and skin conductance) and biobehavioral (such as PERCLOS (percent of eyelid closure) and facial expression) dimensions of the driver. An in-vehicle information system monitors driving states by analyzing these sensor readings and gives alarms to the driver when the danger level exceeds a fixed threshold.

The live prototype system of driving safety based on the instant framework validates the robustness and efficiency of the approach. The TD learning takes about several minutes to approximate the linear danger level function and about one hour for nonlinear approximation. But the testing process is completely real-time. Based on the off-line approximation of the danger level function, a live prototype system predicts unsafe system states. The system consists of three major modules: 1) The data acquisition module that captures the vehicle's dynamic parameters in realtime; 2) The feature extraction module that converts the raw sensor readings and individual mistakes into predefined statistical features; 3) The prediction module that feeds the extracted features to the danger level function and lively outputs numerical danger level scores. The score triggers the warning interface if it exceeds a predefined threshold learned from training samples.

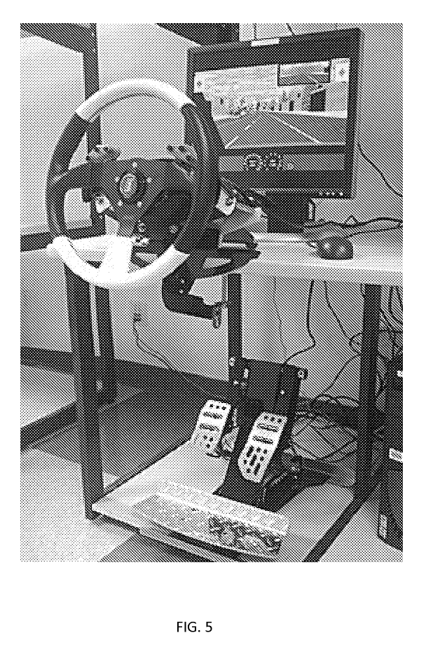

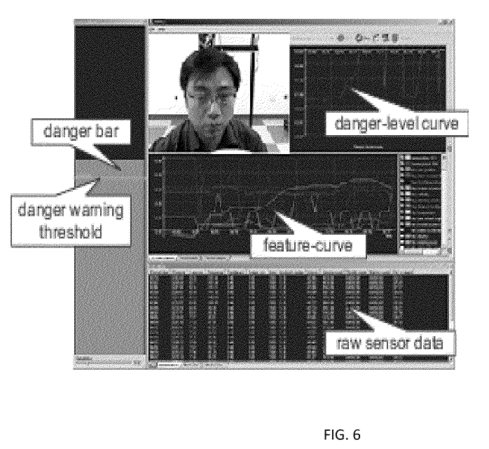

FIG. 5 shows one prototype system where the left screen displays the driving scenario and the right screen is the interface of the prediction module. A detailed description of the interface is given in FIG. 6. A subjective online test was conducted where 11 participants were invited to operate the system. Results showed that the system can accurately predict driving risks due to sharp turning, sudden acceleration/decelation, continues weaving, approaching objects, etc. It is sensitive to the driver's state change (e.g., fatigue) and the road condition change (e.g., windy and slippery road), because these changes usually results in the changes of driving states.

The data were collected through the STISIM vehicle simulator from Systems Technology, Inc. (STI). STISIM is a personal computer based, interactive driving simulator that allows the driver to control all aspects of driving including the vehicles speed and steering. The system includes a computer with the STISIM software, a projector displaying the driving scenarios, a steering wheel, and brake and throttle pedals. The driving scenario, including windy weather, slippy road, red light, stop-sign, speed limit, pedestrian, policeman, buildings, and so on, was carefully designed to make the data as close as possible to reality. The STISIM simulator can capture on-line various dynamic parameters related to a user's driving states, including time stamp, distance, lateral lane position, acceleration due to the throttle, acceleration due to the brake, velocity, steering input counts, throttle input counts, brake input counts, minimum range between the driver and all vehicles in the driver's direction, minimum range between the driver and all vehicles opposite to the driver's direction, and so on, with resolution as high as 30 samples per second. These sensor readings are the original features. FIG. 4 shows a segment of data samples of lane position, throttle acceleration, brake acceleration, and velocity, where the red mark means a crash due to vehicle collision. STISIM also captures the individual mistakes including speed exceedence, stop-sign violation, red-light ticket, and so on, which form a long-term variable affecting the driving state.

The experiments were done with 36 drivers, and each drives for about 20 minutes, having 1:3 crashes per driving course. Each time one driver is selected for testing and the other drivers for training. The average performance of the 36 drivers is compared with the baselines.

In the experiments, each trajectory contains L=60 frames, and each frame corresponds to a feature extracted from a window with length equal to 15 seconds. The consecutive frames have 80% overlapping. The non-crash trajectories are randomly selected from each driving course but they have no overlapping with any crash trajectory. The ratio of the number of non-crash trajectories to that of crash trajectories is kept to 10:1 for each driving course. So the system have about 1050 non-crash trajectories and 105 crash trajectories extracted from any 15 driving courses for training and leave about 30 non-crash trajectories and 3 crash trajectories extracted from the rest driving course for testing.

The discount factor α is set to e^{ln w/L} where L is the length of the trajectory, such that farthest frame is discounted to at most w. Here α is set to 0.92. In the n-th iteration, the system choose γₙ=100/(100+n^{0.8}), instead of γₙ=c/(d+n), because it makes the updating of r converge more quickly while achieving similar performance. The parameter λ of TD(λ) is set to λ=e^{-n/1000} that is large at the beginning of learning so that the penalty/reward can be quickly propagated backwards from the end of the trajectory, and λ becomes smaller as the learning progresses hence the system could rely more and more on the values of the nearest downstream. In the experiments, the parameter r converges to a stable value after about 10,000 iterations if the approximation architecture of J(Xₜ, r) is linear, and about 100,000 iterations if J(Xₜ,r) is non-linear. In each iteration, a trajectory is randomly sampled from the training set and then put back, i.e., each trajectory can be sampled multiple times.

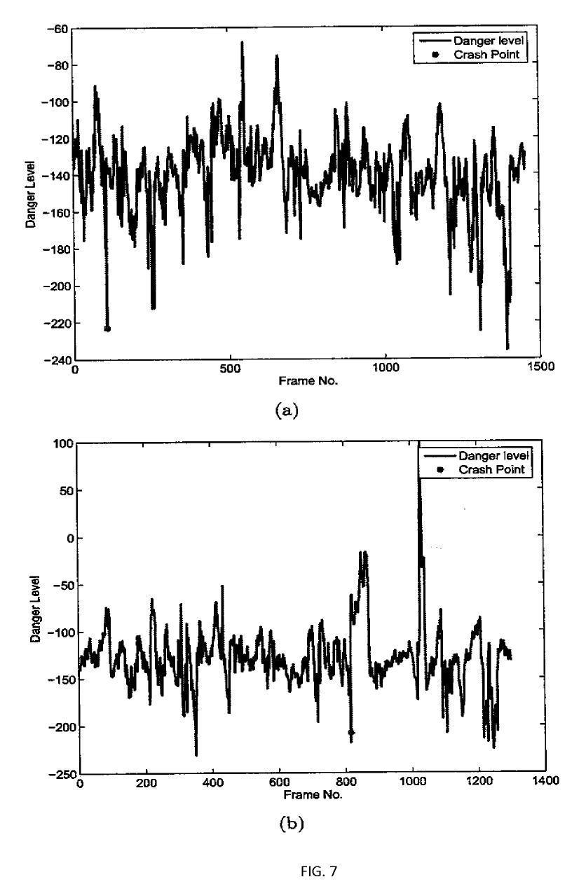

After the parameter vector r is estimated from the training data, the danger level for any testing driving course can be calculated by extracting features and feeding the features to the approximation function. FIG. 7 shows an exemplary danger level function for two testing driving courses constructed by linearly parameterized approximation. The crash points indicated by the red marks and their preceding frames have very small value of danger level that is consistent with that the smaller the danger level the more unsafe the system states. There are some other points having very smaller value of danger level but without crash. Manually checking some of these points by playing back the driving courses in STISIM system shows that the drivers at these points usually take risk of unsafe driving. Since these points are not labelled as “unsafe”, it deteriorates the performance of the test embodiment to some extent.

The performance of the above algorithm is compared with those obtained by two baselines. The first baseline is a two-category classifier using logistic regression that is generally regarded as a safe and robust classifier relying on few assumptions. The training data for training this classifier are manually labelled with hard labels described above. The second baseline approximates function by general linear regression. In this case the training data are manually labelled with soft labels. Note that the training data for both baselines are labelled manually. Therefore, comparing our approach with the baselines demonstrates the effectiveness of avoiding the labelling issue by our approach.

The system specifically defines an evaluation metric to measure the performance of both the instant approach and the baselines. The goal of the evaluation metric is not to compare the “intelligent” versus “unintelligent” systems, but to first determine whether the instant approach is an improvement over no crash warning system and the baselines. The intuitive idea of the metric is to measure how much the probability of accidents increases when the system only looks at the claimed danger time, instead of the total time. The higher the increase, the more power of detecting unsafe driving. But the system needs to exactly specify some important terms so as to quantitatively define the metric.

Since the system doen't have ground truth for the testing data except at the crash points, to make the evaluation feasible, tᵣ seconds before each crash are directly defined as real danger time, assuming that the real danger level at these times is very high. Let Tᵣ be the total real danger time in the testing data and T be the total time. The claimed danger time, denoted as T_{c}, is the time when the value of danger level is below a threshold. Let T_{cr} be the real danger time that is also claimed as danger time by our approach or the baselines. With these definitions, the precision denoted by p can be defined as p=T_{cr}/T_{c}. And pᵣ=Tᵣ/T is the percentage of the real danger time in the total time. Then the ratio R=p/pᵣ expresses how much the probability of accidents increases when the system only looks at the claimed danger time, instead of the total time. The greater the R the better the performance. R is calculated at a certain level of percentage of claimed danger time in total time, denoted as P_{c}=T_{c}/T. Usually lower P_{c} is preferred because a high P_{c} often means a high rate of false alarm that may result in a “cry wolf” effect where drivers cease to trust automation.

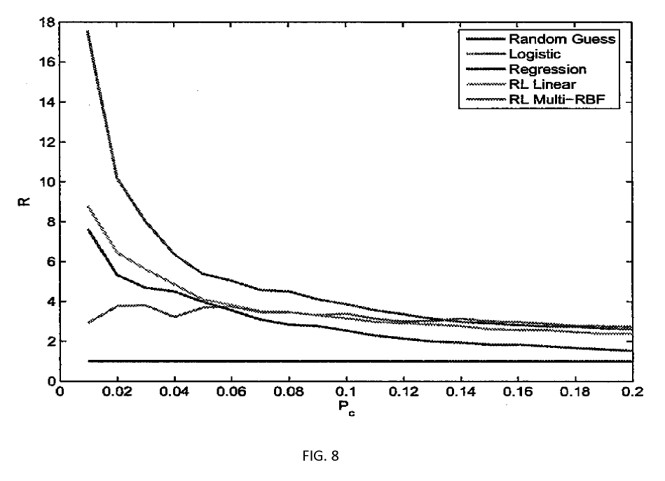

P_{c} can be lowered down by adjusting the threshold for the danger level. Actually a threshold corresponds to a value of P_{c}, and in turn P_{c} determines the R. Therefore, the system can generate a P_{c}−R curve by adjusting the threshold from the minimum to the maximum. The curve represents the performance of the corresponding approach. Note that the real number output, instead of the binary output, of the first baseline (logistic regression) is used so that the system can plot a continuous curve for it. FIG. 8 shows the P_{c}−R curves of both the instant approach and the baselines. The curve for the random guess is always one, which is marked as blue. From FIG. 8, the order of performance at low P_{c}(<5%), from low to high, is random guess<logistic classifier<linear regression<linear TD learning<nonlinear (multi-RBF) TD learning. It shows that the instant approach, both linear and nonlinear TD learning, outperforms the baselines because the instant approach can avoid the labelling issue. Especially, the performance of nonlinear TD learning is much better than those of other methods. The system performance is compared at a low P_{c}(<5%) because the in-vehicle warning system should work at low P_{c}. If the system only looks at the claimed danger time, the possibility of accidents is much higher than the average (R>1), which means that the instant approach can accurately detect unsafe driving.

The above general framework detects unsafe system states. It uses temporal difference learning to approximate a danger level function that indicates how safe/unsafe of the system, by analyzing the multi-sensor data that captures the basic parameters of the system. The system sidesteps the main challenge to the learning procedure is the labelling issue, i.e., it is nearly impossible to label the training data with objective danger level, except at the collapse points where the extremal penalty can be assigned to the danger level and at the successful ends where a certain reward can be assigned. The TD learning avoids the labelling issue and approximates the danger level function by propagating the penalty and reward to the entire feature space following some constraints. The approach is applied to, but not limited to, the application of driving safety and the experimental results and the live prototype system demonstrates the effectiveness of the approach.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to detect unsafe system states, comprising:
capturing and analyzing data from a plurality of sensors detecting parameters of the system; and
applying temporal difference (TD) learning to learn a function to approximate an expected future reward given current and historical sensor readings.

2. The method of claim 1, comprising generating a danger function.

3. The method of claim 2, wherein the danger function comprises values on a continuous and high-dimensional feature space.

4. The method of claim 2, wherein the danger function comprises a suitable approximation J(Xₜ, r), where r is a vector of parameters.

5. The method of claim 4, wherein J(Xₜ, r) comprises a linear function.

6. The method of claim 4, wherein J(Xₜ, r) comprises a non-linear function.

7. The method of claim 4, wherein the non-linear function comprises
$$J ( {X}_{t} , r ) = {\sum }_{i = 1}^{S} {α}_{i} {e}^{- \frac{{X}_{t} - {r}_{i}}{2 {σ}^{2}}} + β .$$

8. The method of claim 2, wherein the danger function comprises a neural network.

9. The method of claim 1, comprising providing a discount factor α,0<α≦1, to the temporal difference
dₛ=g(Xₛ,Xₛ₊₁)+αJ(Xₛ₊₁,r)−J(Xₛ,r)

10. The method of claim 1, comprising treating the danger level as an expected future reward and using temporal difference (TD) learning to generate a danger function to approximate the expected future reward given current and historical sensor readings.

11. The method of claim 10, wherein the TD learning obtains an approximation by propagating a penalty/reward observable at collapse points or successful ends to the entire feature space following one or more predetermined constraints.

12. The method of claim 1, comprising extracting new features from raw data.

13. The method of claim 12, comprising applying to the raw data a transformation \tilde{X}ₜ=T(X_{t-s:t}) where \tilde{X}ₜ is the new feature at time t.

14. The method of claim 1, comprising applying a transformation T to reduce a dimension of a source feature and summarize the information meaningful to unsafety detection.

15. The method of claim 14, wherein T is empirically determined.

16. The method of claim 14, wherein T extracts mean, max, min, and variance from each dimension of the sensor reading and weave from dimensions of lane position and steering wheel.

17. The method of claim 1, comprising detecting a driving safety condition.

18. The method of claim 17, comprising capturing frequency of vehicle oscillation on the lane to detect a driver's skill, fatigue, and drowsiness.

19. The method of claim 1, comprising generating a danger level function J(Xₜ).

20. The method of claim 19, wherein J(Xₜ) implicitly provides a maximum probability that the system will collapse from a current state Xₜ.

21. The method of claim 19, wherein transitioning from state Xₜ to Xₜ₊₁ incurs a danger level change g(Xₜ, Xₜ₊₁).

22. The method of claim 21, wherein J(Xₜ) satisfies Bellman's equation.

23. The method of claim 21, wherein
$$J ( {X}_{t} ) = {min}_{{X}_{t + 1}} ( g ( {X}_{t} , {X}_{t + 1} ) + J ( {X}_{t + 1} ) ) .$$

24. The method of claim 23, comprising applying an incremental gradient method or a nonlinear optimization method to globally determine J(Xₜ).
